(19) United States
(12) Patent Application Publication
(10) Pub. No.: US 2010/0071463 A1
(43) Pub. Date: Mar. 25, 2010

(54) APPARATUS FOR DETERMINING AND/OR MONITORING A PROCESS VARIABLE

(75) Inventor: Dieter Schmidt, Nesselwang (DE)

Correspondence Address: BACON & THOMAS, PLLC, 625 SLATERS LANE, FOURTH FLOOR, ALEXANDRIA, VA, 22314-1176, US

(73) Assignee: Endress + Hauser Wetzer Gmbh + Co. KG, Nesselwang (DE)

(21) Appl. No.: 12/449,099

(22) PCT Filed: Jan. 24, 2008
(86) PCT No.: PCT/EP2008/050826

§ 371 Date: Nov. 20, 2009

(30) Foreign Application Priority Data
Feb. 1, 2007 (DE) 102007005899.5
Jul. 12, 2007 (DE) 102007032882.8

(51) Int. Cl. G01D 11/24

(52) U.S. Cl. 73/431

(57) ABSTRACT

An apparatus for determining and/or monitoring at least one process variable. The apparatus includes at least a first housing unit, which has at least one connecting section for mechanical connection of the first housing unit with a connecting section of a second housing unit. The invention includes the feature that the connecting section of the first housing unit is embodied in such a manner, that, via the connecting section of the first housing unit, connection of the first housing unit with one of at least two, second housing units is producible, wherein the at least two, second housing units differ from one another at least in their connecting sections.

The invention relates to an apparatus for determining and/or monitoring at least one process variable. The apparatus includes at least a first housing unit, which has at least one connecting section for mechanical connection of the first housing unit with a connecting section of a second housing unit. The process variable is, for example, temperature, fill level, pressure, pH value, viscosity, flow, mass flow or density.

In the state of the art, measuring devices are known, which are composed of a plurality of housing units accommodating different components of the measuring device. The housing units are partially fixedly connected with one another, e.g. by welding, soldering or crimping or they are releasably connected with one another, so that also a replacement of individual components is possible. Thus, for example, it is taken into consideration, that the electronics can malfunction or that components, which come in direct contact with the process or a medium, can be damaged. It is known, for example, to use a screwed connection via corresponding screw threads or to apply so-called quick couplings.

The number of possibilities for releasable combinations increases, especially, in the case of products, such as types of measuring devices, where a large number of variants must be produced and stored. For example, an internal thread on a housing unit requires a corresponding external thread on the other housing unit, or an external thread requires an internal thread. Quick couplings imply the availability of appropriately matching contours/structures.

An object of the invention, therefore, is to provide a measuring device, which still permits the plurality of releasable connection options, while, at the same time, reducing the multiplicity of variants.

The invention achieves the object by the features that the connecting section of a first housing unit is embodied in such a manner, that, via a connecting section of the first housing unit, the connection of the first housing unit with one of at least two second housing units is producible, wherein the at least two second housing units differ from one another at least in structure of connecting sections. In the case of the measuring device of the invention, it is, thus, possible, to connect to the first housing unit at least two different second housing units, which differ from one another at least in their connecting sections. If, thus, in the state of the art, there is, in reference to the connecting sections, always a one-to-one relationship between the first housing unit and the second housing unit as regards the type of connection, in contrast, the first housing unit of the invention permits connection with at least two different second housing units. For such purpose, the connecting section of the first housing unit is embodied in such a manner, that linking with either of at least two different second housing units is possible. In such case, in each case, a first housing unit is connected with a second housing unit. The multiplicity of the first housing units is, thus, reduced in such a manner, that the first housing unit is capable of linking with different second housing units.

An embodiment provides that the connecting section of the first housing unit has at least one internal thread.

An embodiment includes, that the connecting section of the first housing unit has at least one external thread.

An embodiment provides that the connecting section of the first housing unit has at least one contour of a quick coupling.

An embodiment includes, that the connecting section of the first housing unit has at least one coupler of a quick coupling.

Connection via inner and outer threads, respectively, or contour and coupler, respectively, for a quick coupling, are options for the linking between the first and the second housing units. In such case, the connecting section of the first housing unit includes at least two of the four structures. In an embodiment, the connecting section of the first housing unit has available at least one internal thread and one external thread. In an additional embodiment, moreover, the contour and coupler, respectively, required for a quick coupling, are provided as part the connecting section.

So-called quick couplings are standardized, for example, under the following standards: ASTM F1122-04 “Standard Specification for Quick Disconnect Couplings”, ISO 6150, ISO 7241-1 and DIN EN 560. For such couplings, a particular contour is required on one side, and, on the other side, a matching coupler. The contour, or the structure of the contour, is, in such case, fixed. The coupler includes movable elements (e.g. an unlocking sleeve, which, after release, automatically springs forward and locks the connection therewith, or balls or plugs), which fit the contour and establish the connection.

An embodiment includes, that the process variable is temperature.

An embodiment includes, that the process variable is pressure, flow, fill level, or a chemical or electrical, measured variable.

An embodiment provides that the first housing unit serves at least for accommodating an electronics unit or an electromechanical unit. The electronics unit serves, for example, for evaluation of a primary measurement signal with respect to the process variable (on occasion, also with reference to a suitably stored calibration or parameter), or the electronics unit serves for further processing of the measured value for the process variable, as regards suitably producing a signal output. In an additional embodiment, there is located in the first housing unit a so-called connecting block, which, most often, is connected inseparably with the measuring component and, most often, includes screw contacts for clamped attachment of a signal cable leading outwards. An electromechanical unit (or, especially a connecting block) is, thus, for example, a terminal block, which includes no active or passive electronic components, but, instead only connection clamps, solder tabs, etc.

An embodiment includes, that the second housing unit serves at least for accommodating a sensing unit for the process variable. In this embodiment, thus, the second housing unit accommodates the actual measuring sensor, i.e. the component, which produces a first measured value or a first, or primary, measurement signal as a function of the process variable and/or of a change of the process variable. The second housing unit performs therewith, on occasion, also the function of a protective unit of the sensing unit against the medium and against the process.

An embodiment includes, that the second housing unit is a protective tube.

An embodiment provides that at least one electrical connecting unit is provided, which serves for electrical connection between the first housing unit and the second housing unit. This electrical connection occurs, for example, via a plug contact, or via capacitive, inductive or optical coupling. Preferably, the connecting unit also provides the connection of the sensing unit with the electronics unit or the connecting block in the first housing unit.

An embodiment includes, that the electrical connecting unit is embodied in such a manner, that it permits rotation of the first housing unit and/or the second housing unit about at least one longitudinal axis. Such rotation is advantageous, for example, for the screwing of one thread into another, or also for orientation of the measuring device, or for orientation of a display.

An embodiment includes, that at least one coupling unit is provided, which is embodied in such a manner, that the coupling unit is connectable with the connecting section of the first housing unit and serves for reception of the second housing unit or that the coupling unit is connectable with the connecting section of the second housing unit and serves for the reception of the first housing unit. In this embodiment, thus, a coupling unit is provided, which enables the adapting of the two connecting sections. This serves, for example, for the fitting of other connection types or also different diameters or thread pitches.

An embodiment provides, that the coupling unit is embodied in such a manner, that the coupling unit provides the coupler for effecting a quick coupling. I.e., the coupling unit provides, for example, the suitable structure with the movable elements of the coupler, which, in interaction with the contour, produce the quick connection. I.e., located in the coupling unit are the movable elements, which shift into the fitting countercontour to provide the quick coupling.

An embodiment includes, that at least one monitoring unit is provided, which at least monitors the state of a sealing function between the first housing unit and the second housing unit. Such a monitoring unit monitors, thus, for example, whether medium has penetrated in the interior of one of the two housing units. Referenced in this connection are the two Offenlegungsschrifts DE 10 2004 014 600 A1 and DE 103 55 784 A1.

The invention will now be explained in greater detail on the basis of the appended drawing, the figures of which show as follows:

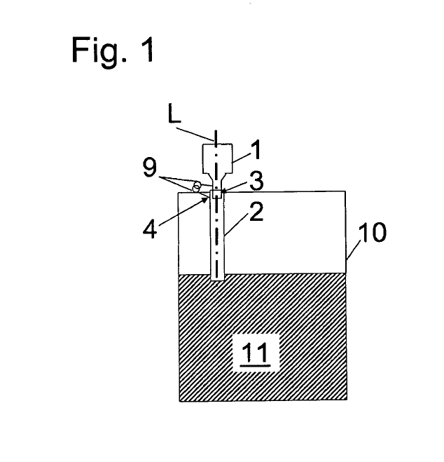

FIG. 1 a schematic drawing of the application of a measuring device of the invention for measuring, or monitoring, a process variable of a medium in a container;

FIG. 2 a section through a measuring device of the invention in connection with a protective tube in a first connection option;

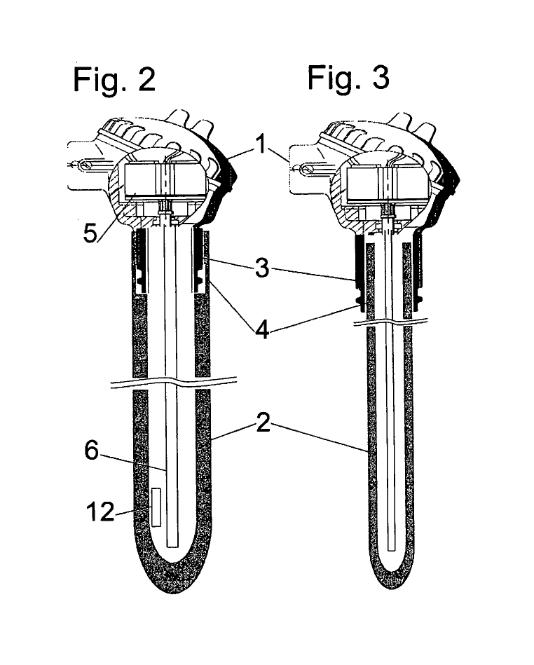

FIG. 3 a section through a second connection option;

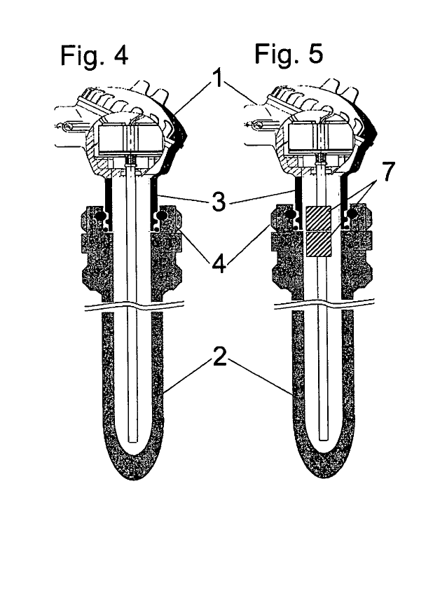

FIG. 4 a section through a third connection option;

FIG. 5 a section through a third connection option having a direct electrical connection;

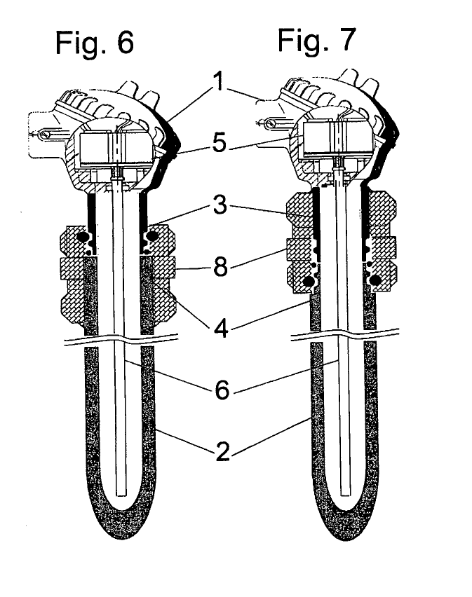

FIG. 6 a section through a measuring device of the invention, in the case of which a coupling unit is used; and

FIG. 7 a section through an application of the coupling unit alternative to the embodiment illustrated in FIG. 6.

FIG. 1 shows, schematically, a measuring device of the invention in the case of application, wherein the measuring device is mounted on a container 10, which contains a medium 11. Shown is a first housing unit 1, in which, for example, the electronics unit for determining and/or monitoring the process variable is located. This electronics unit is, in most cases, also referred to as a transmitter. In an additional embodiment, located in the first housing unit 1 is a connecting block, which serves, for example, for contacting a signal line for leading the measuring signal out from a sensing unit in the second housing unit 2. The process variable is, for example, temperature, fill level, pressure, pH value, viscosity, flow, mass flow or density. Connected with the first housing unit 1 is a second housing unit 2.

The connection is preferably releasable, i.e. the two housing units 1, 2 can be separated from one another. In the second housing unit 2 is located a sensing unit, which produces a direct measured variable, which depends on the process variable or a change of the process variable. Ascertained from this direct measured variable, for example, by the electronics unit in the first housing unit 1, is, then, the value for the process variable, or the change of the process variable. In the case illustrated here, in which the process variable is temperature, the sensing unit is the actual temperature sensor, which, for example, changes its electrical resistance, as direct measured variable, as a function of the reigning temperature. From the resistance, or from a change of the value, then the electronics unit ascertains the process variable, or its change. The transmitter includes, in this case, furthermore, a driving unit, or a measuring unit, for measuring the electrical resistance. In an additional embodiment, the sensing unit includes at least one heat pipe for transmission of the temperature to a sensor unit. The second housing unit 2 serves in the illustrated case as protective tube for the sensor unit relative to the medium.

Due to the multiplicity known in the state of the art for the releasable mechanical connection of the two housing units 1, (quick couplings or a screwed connections with threads, wherein inner and outer threads are located, respectively, on the one or the other of the housing units) there results also a corresponding multiplicity with respect to the variants of such a measuring device. This implies high storage and stocking costs. Such problem is met by the measuring device of the invention by the features that the first housing unit 1 permits connection with different, second housing units 2, i.e. especially for the here illustrated case, with different protective tubes. This makes it possible to take into consideration, that there are, on the market, differently embodied, protective tubes, which can continue to be used in connection with the first housing unit 1. For implementing the different connection opportunities, the connecting section 3 of the first housing unit 1 is embodied in such a manner, that it permits, for example, connection with an external thread and with an internal thread and, on occasion, also with a quick coupling. If, thus, in the state of the art, the housing unit 1 has usually either only an external thread or only an internal thread, in contrast, here, the connecting section 3 is characterized, in an embodiment, by the fact that it permits, especially, connection with three different protective tubes, as a result of the features that the connecting section 3 includes both an external thread, as well as also an internal thread and, moreover, a contour for quick coupling. FIG. 1 shows, also, the longitudinal axis L, about which, advantageously, rotation of the two housing units 1, 2 relative to one another is possible. To accomplish this, for example, an electrical connecting unit is suitably embodied.

In the illustrated embodiment, each of the two housing units 1, 2 includes an eye 9. The two eyes 9 serve, for example, to permit application of a tamper-evident seal, in order, thus, to detect manipulations of, or changes to, the measuring device.

FIG. 2 shows a measuring device of the invention in section in more detail. In the first housing unit 1 is located a so-called head transmitter as electronics unit 5, which is responsible, for example, for electrical current supply, for supplying the sensing unit 6 with a signal, and for evaluation and/or further processing of the direct, or primary, measurement signal of the sensing unit 6. Sensing unit 6 is protected by the second housing unit 2 against the medium, or against the process. In order to be able to replace the electronics unit 5, the sensing unit 6 or, for example, in the case of corresponding impairment, the second housing unit 2, the first housing unit 1 and the second housing unit 2 are connected releasably with one another. This is accomplished in the variant illustrated in FIG. 2 by the fact that the connection region 4 of the second housing unit 2 has an internal thread and that, fittingly, the external thread of the connection region 3 of the first housing unit 1 is used. I.e., the first housing unit 1 is screwed via its connection region 3 into the connection region 4 of the second housing unit 2.

In the second housing unit 2 is located, here, also, a monitoring unit 12, which is, for example, a humidity sensor or a pressure sensor or a conductivity sensor. If medium penetrates into the second housing unit 2, then the monitoring unit 12 reports a change in its measured variable, for example, to the electronics unit 5 in the first housing unit 1. Preferably, at least one seal is provided in the region of the connecting sections 3, 4. The effectiveness of the sealing can be monitored via the monitoring unit 12.

FIG. 3 shows the reverse case to that illustrated in FIG. 2. Thus, the connecting section 4 of the second housing unit 2 has an external thread, so that the internal thread of the connecting section 3 of the first housing unit 2 is used.

FIGS. 2 and 3 illustrate, thus, that a first housing unit 1, based on universal construction of the connecting section 3, permits connection with at least two different protective tubes, or second housing units 2.

In FIGS. 4 and 5, the contour of the connecting section 3 is used for a quick coupling. As can be seen, thus, the second housing unit 2 here includes in its connecting section 4 a corresponding counterstructure, or, more exactly, the coupler, which allows the quick coupling, in that the movable elements of the coupler suitably move into the contour.

The connecting section 3 of the first housing unit 1 is, thus, embodied in such a manner, that the outside has both an external thread, as well as also a contour for a quick coupling. In an additional embodiment, the external thread and the contour for the quick coupling are located at different heights.

In FIGS. 2 to 4, the sensing unit 6 is always directly connected with the electronics unit 5. In an embodiment, thus, the sensing unit 6, already connected with the electronics unit 5 and therewith also with the first housing unit 1, is brought into the second housing unit 2, and the two housing units 1, 2 are mechanically connected with one another via the two connecting regions 3, 4. For this, it is advantageous, when the sensing unit 6, especially for the connection types of FIGS. 2 and 3, is rotatable in the second housing unit 2.

In FIG. 5, an electrical contacting between the electronics unit 5 and the sensing unit 6 takes place via two electrical connecting units 7. The connecting units 7 are, for example, a plug contact and a suitably receiving unit or two contact locations for a capacitive, inductive or optical signal and/or energy transmission. The two electrical connecting units 7 are, in such case, especially embodied in such a manner, that they permit a rotation about the longitudinal axis L (compare FIG. 1) of the measuring device.

FIG. 6 shows a variant, in which the coupler of a quick coupling is provided by a coupling unit 8. This coupling unit 8 is suitably connected, either fixedly or even releasably, with the second housing unit 2, and enables, thus, the establishment of a quick coupling with the first housing unit 1. I.e., by the coupling unit 8, the second housing unit 2 is suitably prepared for linking to the first housing unit 1.

FIG. 7 shows the reverse case, wherein, through the coupling unit 8, a quick coupling with the second housing unit 2 is produced. This is, for example, advantageous, when a replacement of the protective tube 2 is required often.

In FIGS. 6 and 7, thus, the coupling unit 8 serves as adapter between the two connecting sections 3 and 4.

### LIST OF REFERENCE CHARACTERS

1 first housing unit

2 second housing unit

3 connecting section of the first housing unit

4 connecting section of the second housing unit

5 electronics unit

6 sensing unit

7 electrical connecting unit

8 coupling unit

9 eye

10 container

11 medium

12 monitoring unit

1-15. (canceled)

16. An apparatus for determining and/or monitoring at least one process variable, comprising:
at least a first housing unit;
at least one connecting section for mechanical connection of said at least a first housing unit with a connecting section of one of said at least two second housing units; wherein:
said at least one connecting section of said at least a first housing unit is embodied in such a manner that, via said at least one connecting section of said at least one first housing unit, connection of said at least a first housing unit with one of said at least two second housing units is producible, and said at least two second housing units differ from one another at least in their connecting sections.

17. The apparatus as claimed in claim 16, wherein:
sat at least one connecting section of said at least a first housing unit has at least one internal thread.

18. The apparatus as claimed in claim 16, wherein:
said at least one connecting section of said at least a first housing unit has at least one external thread.

19. The apparatus as claimed in claim 16, wherein:
said at least one connecting section of said at least a first housing unit has at least one contour of a quick coupling.

20. The apparatus as claimed in claim 16, wherein:
said at least one connecting section of said at least a first housing unit has at least one coupler of a quick coupling.

21. The apparatus as claimed in claim 16, wherein:
the process variable is temperature.

22. The apparatus as claimed in claim 16, wherein:
the process variable is pressure, flow, fill level, a chemical or an electrical, measured variable.

23. The apparatus as claimed in claim 16, wherein:
said at least a first housing unit serves at least for accommodating an electronics unit or an electromechanical unit.

24. The apparatus as claimed in claim 16, wherein:
said one of said at least two second housing unit serves at least for accommodating a sensing unit for the process variable.

25. The apparatus as claimed in claim 24, wherein:
said one of said at least two second housing units is a protective tube.

26. The apparatus as claimed in claim 24, further comprising:
at least one electrical connecting unit which serves for electrical connection between said at least a first housing unit and said one of said at least two second housing units.

27. The apparatus as claimed in claim 26, wherein:
said at least one electrical connecting unit is embodied in such a manner, that it permits rotation of said at least a first housing unit and/or one of said at least two second housing units about at least one longitudinal axis.

28. The apparatus as claimed in claim 16, further comprising:
at least one coupling unit, which is embodied in such a manner, that it is connectable with said at least one connecting section of said at least a first housing unit and serves for receiving said one of said at least two second housing units or that said at least one coupling unit is connectable with said connecting section of the said one of said two second housing units and serves for receiving said at least a first housing unit.

29. The apparatus as claimed in claim 28, wherein:
said coupling unit is embodied in such a manner, that it provides a coupler for producing a quick coupling.

30. The apparatus as claimed in claim 16, further comprising:
at least one monitoring unit, which at least monitors the state of a sealing function between said at least a first housing unit and one of said two second housing units.
